(19) United States
(12) Patent Application Publication
(10) Pub. No.: US 2011/0044552 A1
(43) Pub. Date: Feb. 24, 2011

(54) System and method for enhancement of images in a selected region of interest of a captured image

(76) Inventors: Jonathan Yen, San Jose, CA (US); Tony Quach, Anaheim, CA (US)

Correspondence Address: SoCAL IP LAW GROUP LLP, 310 N. WESTLAKE BLVD. STE 120, WESTLAKE VILLAGE, CA, 91362, US

(21) Appl. No.: 12/583,625

(22) Filed: Aug. 24, 2009

(51) Int. Cl. G06K 9/40

(52) U.S. Cl. 382/254

(57) ABSTRACT

The subject application is directed to a system and method for image enhancement. Image data is received that contains a rectangular array of pixels encoded in a multidimensional color space. The image data is scaled to a scaled rectangular array having a smaller number of pixels such that both a selected rectangular dimension and a complimentary dimension are scaled to preselected dimension values. Region-of-interest data is received for an isolated region in the image data. A mask matrix, having a rectangular array of elements corresponding to pixels of the scaled rectangular array, is stored. The mask matrix, populated using region-of-interest data, has first and second values associated with each entry, with the first value, but not the second value, corresponding to a region of interest in the scaled rectangular array. Received image data is adjusted according to image data values based on pixel values associated with first value elements.

### BACKGROUND OF THE INVENTION

The subject application is directed generally to enhancement of captured images. The application is particularly applicable to enhancement of image portions in a selected region of interest of a captured image.

Most image capturing devices, such as cameras or scanners, are digital devices. Relatively high resolution color or black-and-white images are captured as an array of pixels encoded in a multidimensional color space.

Captured digital images suffer from some of the same deleterious effects associated with earlier image capture systems, such as those captured with cameras employing color or black-and-white film. Such factors may include backlit images, which result from when a subject is positioned between a camera and a light source. Backlit images result in a captured image wherein detail of the subject is lost given the overpowering light that is captured from an area surrounding a subject. This problem is particularly acute when trying to capture a human being, especially the all-important facial region.

Migration to digital image capture opens opportunities for mathematical manipulation of captured image data to algorithmically address image artifacts resultant from less-than-ideal imaging situations

### SUMMARY OF THE INVENTION

In accordance with one embodiment of the subject application, there is provided a system and method of image enhancement. Image data is first received into a memory, which image data comprises a rectangular array of pixels encoded in a multidimensional color space. The image data is then scaled to a scaled rectangular array of pixels having a smaller number of pixels than the rectangular array of the received image data. The scaling is performed such that a selected rectangular dimension of the received image data is scaled to a preselected dimension value, and a dimension complementary to the selected rectangular dimension of the image data is also correspondingly scaled. Region-of-interest data is then received that corresponds to at least one isolated region of interest in the received image data. A mask matrix, which has a rectangular array of elements corresponding to pixels of the scaled rectangular array, is then stored in the memory. In addition, the mask matrix, which is populated in accordance with the received region-of-interest data, has a first value associated with each entry corresponding to a region of interest of image data in the scaled rectangular array, and also has a second value associated with each entry not corresponding to the region of interest. Thereafter, the received image data is adjusted according to image data values corresponding to the pixel values associated with mask elements having the first value.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The patent or application file contains at least one drawing executed in color. Copies of this patent or patent application publication with color drawings will be provided by the Office upon request and payment of the necessary fee. The subject application is described with reference to certain figures, including:

FIG. 1 is an overall diagram of a system of image enhancement according to one embodiment of the subject application;

FIG. 2 is a block diagram illustrating device hardware for use in the system of image enhancement according to one embodiment of the subject application;

FIG. 3 is a functional diagram illustrating the device for use in the system of image enhancement according to one embodiment of the subject application;

FIG. 4 is a block diagram illustrating controller hardware for use in the system of image enhancement according to one embodiment of the subject application;

FIG. 5 is a functional diagram illustrating the controller for use in the system of image enhancement according to one embodiment of the subject application;

FIG. 6 is a diagram illustrating a workstation for use in the system of image enhancement according to one embodiment of the subject application;

FIG. 7 is a block diagram illustrating a system of image enhancement according to one embodiment of the subject application;

FIG. 8 is a functional diagram illustrating a system of image enhancement according to one embodiment of the subject application;

FIG. 9 is a flowchart illustrating a method of image enhancement according to one embodiment of the subject application;

FIG. 10 is a flowchart illustrating a method of image enhancement according to one embodiment of the subject application;

FIG. 11 is an example input image and facial detection results used in accordance with the system of image enhancement according to one embodiment of the subject application;

FIG. 12 depicts example input image, scanning window, and mask image used in accordance with the system of image enhancement according to one embodiment of the subject application;

FIG. 13 illustrates an input image and associated skin tone mask in accordance with the system of image enhancement according to one embodiment of the subject application;

FIG. 14 depicts detection results of FIG. 13 using a skin tone mask in accordance with the system of image enhancement according to one embodiment of the subject application;

FIG. 15 illustrates an input image, region-of-interest, and scanning window used in accordance with the system of image enhancement according to one embodiment of the subject application;

FIG. 16 is an example input image and region-of-interest mask in accordance with the system of image enhancement according to one embodiment of the subject application;

FIG. 17 is the input image of FIG. 16 and detection box in accordance with the system of image enhancement according to one embodiment of the subject application;

FIG. 18 depicts an example detection result of FIG. 17 using a region-of-interest mask in accordance with the system of image enhancement according to one embodiment of the subject application;

FIG. 19 illustrates an example skin tone mask and region-of-interest mask in accordance with the system of image enhancement according to one embodiment of the subject application;

FIG. 20 illustrates an input image, logically combined region-of-interest mask, and detection box in accordance with the system of image enhancement according to one embodiment of the subject application;

FIG. 21 illustrates the example input image of FIG. 11 and associated region-of-interest mask in accordance with the system of image enhancement according to one embodiment of the subject application; and

FIG. 22 illustrates an input image and detection box overlay in accordance with the system of image enhancement according to one embodiment of the subject application.

### DETAILED DESCRIPTION OF THE PREFERRED EMBODIMENT

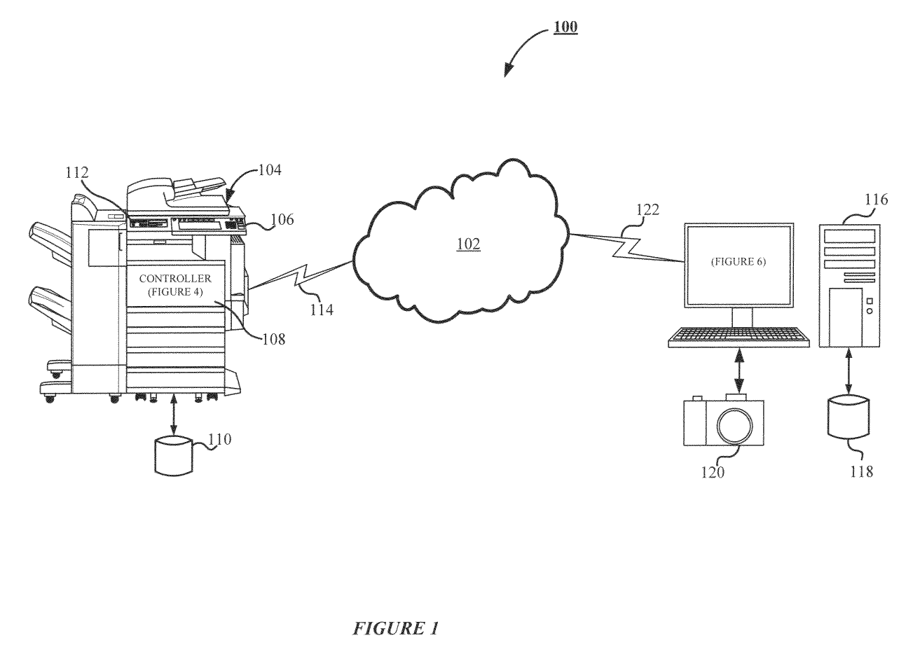

The subject application is directed to a system and method of image enhancement. In particular, the subject application is directed to a system and method for enhancing captured images. More particularly, the subject application is directed to a system and method for the enhancement of image portions in a selected region of interest of a captured image. It will become apparent to those skilled in the art that the system and method described herein are suitably adapted to a plurality of varying electronic fields employing data detection and correction, including, for example and without limitation, communications, general computing, data processing, document processing, financial transactions, vending of products or services, or the like. The preferred embodiment, as depicted in FIG. 1, illustrates a document or imaging processing field for example purposes only and is not a limitation of the subject application solely to such a field.

Referring now to FIG. 1, there is shown an overall diagram of a type system 100 of image enhancement in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes a document processing device 104, which is depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like.

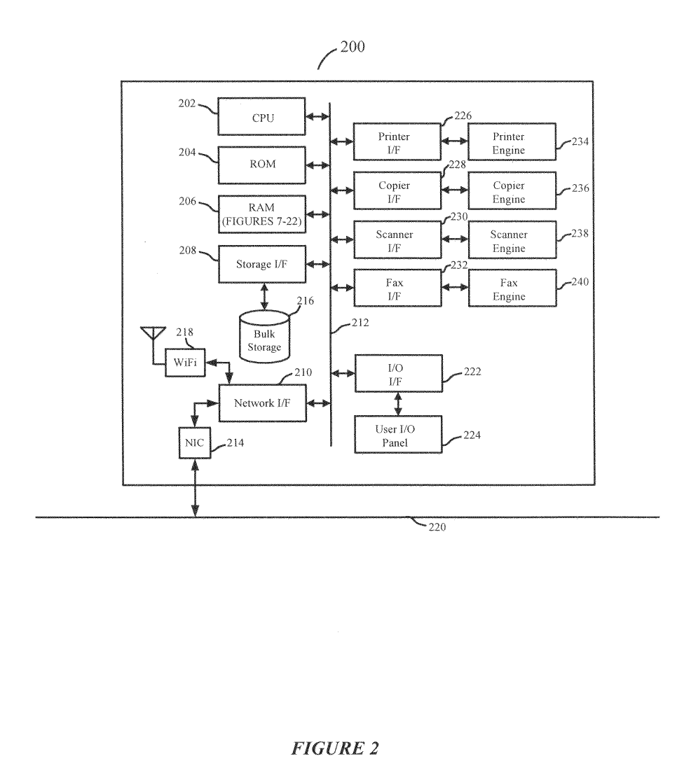

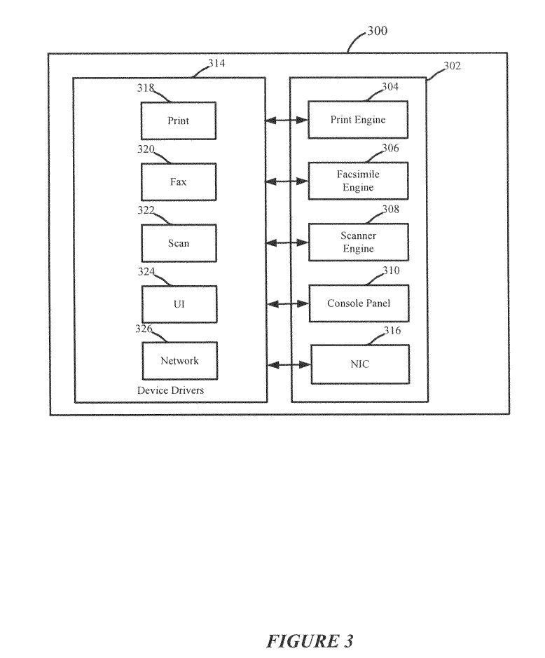

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touchscreen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as the controller 108, as explained in greater detail below. Preferably, the document processing device 104 is communicatively coupled to the computer network 102 via a communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art. The functioning of the document processing device 104 will be better understood in conjunction with the block diagrams illustrated in FIGS. 2 and 3, explained in greater detail below.

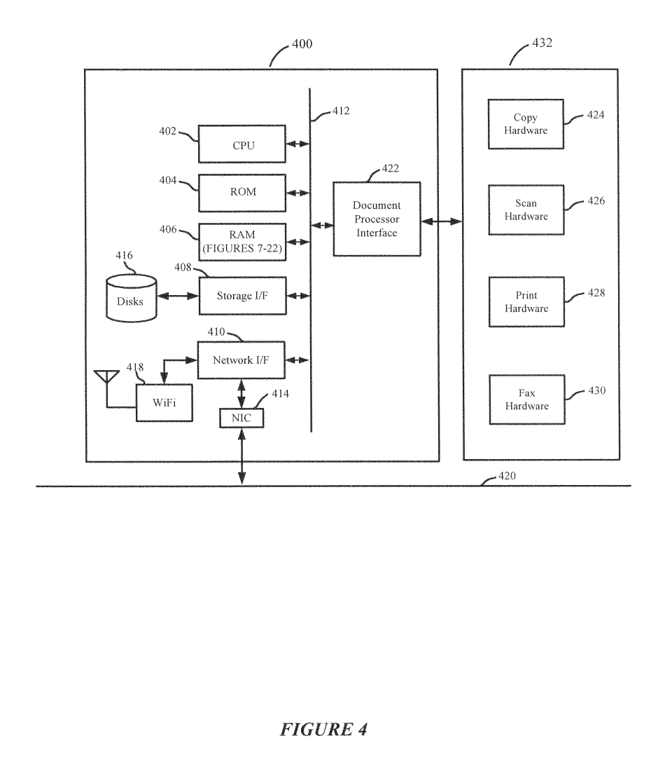

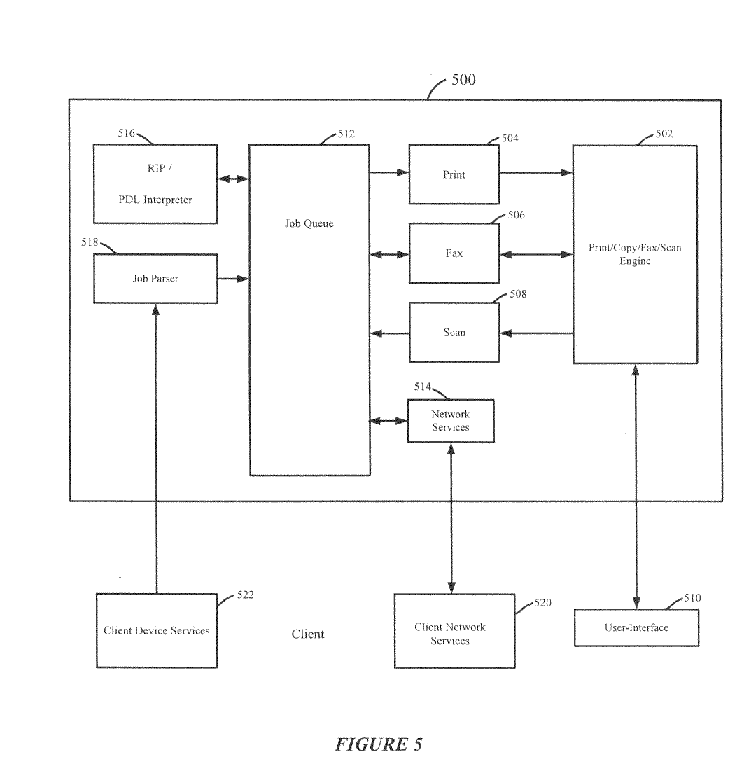

In accordance with one embodiment of the subject application, the document processing device 104 incorporates a backend component, designated as the controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 is capable of being performed by any general purpose computing system, known in the art, and thus the controller 108 is representative of such general computing devices and is intended as such when used hereinafter. Furthermore, the use of the controller 108 hereinafter is for the example embodiment only, and other embodiments, which will be apparent to one skilled in the art, are capable of employing the system and method of image enhancement. The functioning of the controller 108 will better be understood in conjunction with the block diagrams illustrated in FIGS. 4 and 5, explained in greater detail below.

Communicatively coupled to the document processing device 104 is a data storage device 110. In accordance with the one embodiment of the subject application, the data storage device 110 is any mass storage device known in the art including, for example and without limitation, magnetic storage drives, a hard disk drive, optical storage devices, flash memory devices, or any suitable combination thereof. In one embodiment, the data storage device 110 is suitably adapted to store scanned image data, modified image data, redacted data, user information, document data, image data, electronic database data, or the like. It will be appreciated by those skilled in the art that while illustrated in FIG. 1 as being a separate component of the system 100, the data storage device 110 is capable of being implemented as an internal storage component of the document processing device 104, a component of the controller 108, or the like, such as, for example and without limitation, an internal hard disk drive, or the like. In accordance with one embodiment of the subject application, the data storage device 110 is capable of storing document processing instructions, usage data, user interface data, job control data, controller status data, component execution data, images, advertisements, user information, location information, output templates, mapping data, multimedia data files, fonts, and the like. The document processing device of FIG. 1 also includes a portable storage device reader 114, which is suitably adapted to receive and access a myriad of different portable storage devices. Examples of such portable storage devices include, for example and without limitation, flash-based memory such as SD, xD, Memory Stick, compact flash, CD-ROM, DVD-ROM, USB flash drives, or other magnetic or optical storage devices, as will be known in the art.

Also depicted in FIG. 1 is a user device 116, illustrated as a computer workstation, in data communication with the computer network 102 via a communications link 122. It will be appreciated by those skilled in the art that the user device 116 is shown in FIG. 1 as a workstation computer for illustration purposes only. As will be understood by those skilled in the art, the user device 116 is representative of any personal computing device known in the art including, for example and without limitation, a laptop computer, a personal computer, a personal data assistant, a web-enabled cellular telephone, a smart phone, a proprietary network device, or other web-enabled electronic device. According to one embodiment of the subject application, the user device 116 further includes software, hardware, or a suitable combination thereof configured to interact with the document processing device 104, or the like.

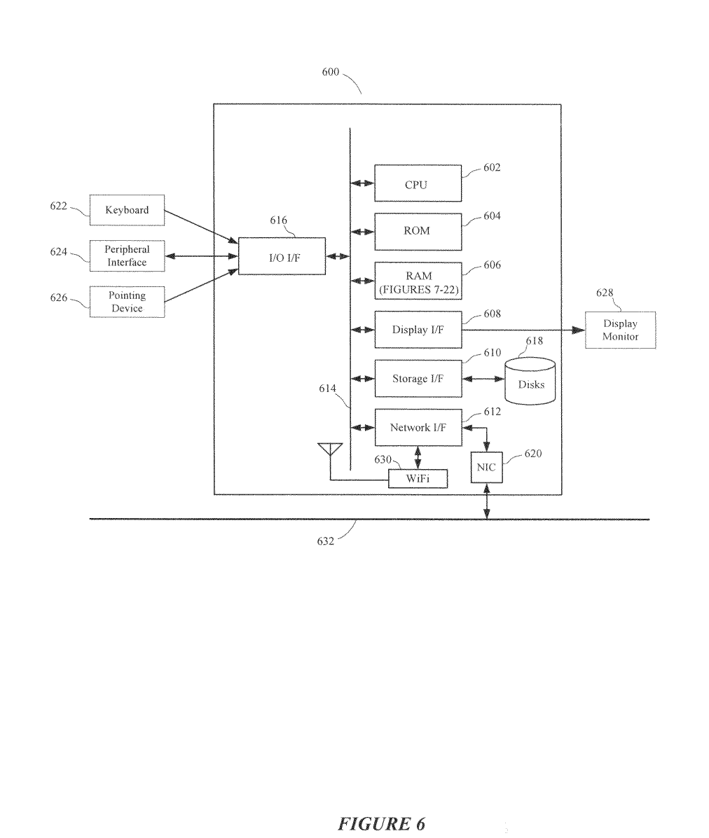

The communications link 122 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the computer workstation 116 is suitably adapted to provide document data, job data, user interface data, image data, monitor document processing jobs, employ thin-client interfaces, generate display data, generate output data, or the like, with respect to the document rendering device 104, or any other similar device coupled to the computer network 102. The functioning of the user device 116 will better be understood in conjunction with the block diagram illustrated in FIG. 6, explained in greater detail below.

Communicatively coupled to the user device 116 is a suitable memory, illustrated in FIG. 1 as the data storage device 118. According to one embodiment of the subject application, the data storage device 118 is any mass storage device known in the art including, for example and without limitation, magnetic storage drives, a hard disk drive, optical storage devices, flash memory devices, or any suitable combination thereof. In accordance with one embodiment of the subject application, the data storage device 118 is suitably adapted to store scanned image data, modified image data, document data, image data, color processing data, or the like. It will be appreciated by those skilled in the art that while illustrated in FIG. 1 as being a separate component of the system 100, the data storage device 118 is capable of being implemented as an internal storage component of the user device 116, such as, for example and without limitation, an internal hard disk drive, or the like

Additionally, the system 100 of FIG. 1 depicts an image capture device, illustrated as a digital camera 120 in data communication with the user device 116. The skilled artisan will appreciate that the camera 120 is representative of any image capturing device known in the art, and is capable of being in data communication with the document processing device 104, the user device 116, or the like. In accordance with one embodiment of the subject application, the camera 120 is capable of functioning as a portable storage device via which image data is received by the user device 116, as will be understood by those skilled in the art.

Turning now to FIG. 2, illustrated is a representative architecture of a suitable device 200, shown in FIG. 1 as the document processing device 104, on which operations of the subject system are completed. Included is a processor 202, suitably comprised of a central processor unit. However, it will be appreciated that the processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the device 200.

Also included in the device 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the device 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by the bus 212.

Suitable executable instructions on the device 200 facilitate communication with a plurality of external devices, such as workstations, document processing devices, other servers, or the like. While, in operation, a typical device operates autonomously, it is to be appreciated that direct control by a local user is sometimes desirable, and is suitably accomplished via an optional input/output interface 222 to a user input/output panel 224 as will be appreciated by one of ordinary skill in the art.

Also in data communication with the bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device, depicted in FIG. 1 as the document processing device 104, for use in connection with the disclosed system. FIG. 3 illustrates suitable functionality of the hardware of FIG. 2 in connection with software and operating system functionality as will be appreciated by one of ordinary skill in the art. The document processing device 300 suitably includes an engine 302 which facilitates one or more document processing operations.

The document processing engine 302 suitably includes a print engine 304, facsimile engine 306, scanner engine 308 and console panel 310. The print engine 304 allows for output of physical documents representative of an electronic document communicated to the processing device 300. The facsimile engine 306 suitably communicates to or from external facsimile devices via a device, such as a fax modem.

The scanner engine 308 suitably functions to receive hard copy documents and in turn image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 3, the document processing engine also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers allow for data interchange from the document processing engine 302 to one or more physical devices to accomplish the actual document processing operations. Such document processing operations include one or more of printing via driver 318, facsimile communication via driver 320, scanning via driver 322 and a user interface functions via driver 324. It will be appreciated that these various devices are integrated with one or more corresponding engines associated with the document processing engine 302. It is to be appreciated that any set or subset of document processing operations are contemplated herein. Document processors which include a plurality of available document processing options are referred to as multi-function peripherals.

Turning now to FIG. 4, illustrated is a representative architecture of a suitable backend component, i.e., the controller 400, shown in FIG. 1 as the controller 108, on which operations of the subject system 100 are completed. The skilled artisan will understand that the controller 400 is representative of any general computing device, known in the art, capable of facilitating the methodologies described herein. Included is a processor 402, suitably comprised of a central processor unit. However, it will be appreciated that processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the controller 400.

Also included in the controller 400 is random access memory 406, suitably formed of dynamic random access memory, static random access memory, or any other suitable, addressable and writable memory system. Random access memory provides a storage area for data instructions associated with applications and data handling accomplished by processor 402.

A storage interface 408 suitably provides a mechanism for non-volatile, bulk or long term storage of data associated with the controller 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the controller 400 to communicate to other devices. The network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 414 is interconnected for data interchange via a physical network 420, suitably comprised of a local area network, wide area network, or a combination thereof.

Data communication between the processor 402, read only memory 404, random access memory 406, storage interface 408 and the network interface subsystem 410 is suitably accomplished via a bus data transfer mechanism, such as illustrated by bus 412.

Also in data communication with the bus 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 400 of FIG. 4, (shown in FIG. 1 as the controller 108) as an intelligent subsystem associated with a document processing device. In the illustration of FIG. 5, controller function 500 in the preferred embodiment includes a document processing engine 502. Suitable controller functionality is that incorporated into the Toshiba e-Studio system in the preferred embodiment. FIG. 5 illustrates suitable functionality of the hardware of FIG. 4 in connection with software and operating system functionality as will be appreciated by one of ordinary skill in the art.

In the preferred embodiment, the engine 502 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that perform one or more of the document processing operations listed above.

The engine 502 is suitably interfaced to a user interface panel 510, which panel allows for a user or administrator to access functionality controlled by the engine 502. Access is suitably enabled via an interface local to the controller, or remotely via a remote thin or thick client.

The engine 502 is in data communication with the print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 308 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506 or scan 508.

Finally, the job queue 512 is in data communication with a parser 518, which parser suitably functions to receive print job language files from an external device, such as client device services 522. The client device services 522 suitably include printing, facsimile transmission, or other suitable input of an electronic document for which handling by the controller function 500 is advantageous. The parser 518 functions to interpret a received electronic document file and relay it to the job queue 512 for handling in connection with the afore-described functionality and components.

Turning now to FIG. 6, illustrated is a hardware diagram of a suitable workstation 600, shown in FIG. 1 as the user device 116, for use in connection with the subject system. A suitable workstation includes a processor unit 602 which is advantageously placed in data communication with read only memory 604, suitably non-volatile read only memory, volatile read only memory or a combination thereof, random access memory 606, display interface 608, storage interface 610, and network interface 612. In a preferred embodiment, interface to the foregoing modules is suitably accomplished via a bus 614.

The read only memory 604 suitably includes firmware, such as static data or fixed instructions, such as BIOS, system functions, configuration data, and other routines used for operation of the workstation 600 via CPU 602.

The random access memory 606 provides a storage area for data and instructions associated with applications and data handling accomplished by the processor 602.

The display interface 608 receives data or instructions from other components on the bus 614, which data is specific to generating a display to facilitate a user interface. The display interface 608 suitably provides output to a display terminal 628, suitably a video display device such as a monitor, LCD, plasma, or any other suitable visual output device as will be appreciated by one of ordinary skill in the art.

The storage interface 610 suitably provides a mechanism for non-volatile, bulk or long term storage of data or instructions in the workstation 600. The storage interface 610 suitably uses a storage mechanism, such as storage 618, suitably comprised of a disk, tape, CD, DVD, or other relatively higher capacity addressable or serial storage medium.

The network interface 612 suitably communicates to at least one other network interface, shown as network interface 620, such as a network interface card, and wireless network interface 630, such as a WiFi wireless network card. It will be appreciated that by one of ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitable wireless network system, as will be appreciated by one of ordinary skill in the art. In the illustration, the network interface 620 is interconnected for data interchange via a physical network 632, suitably comprised of a local area network, wide area network, or a combination thereof.

An input/output interface 616 in data communication with the bus 614 is suitably connected with an input device 622, such as a keyboard or the like. The input/output interface 616 also suitably provides data output to a peripheral interface 624, such as a USB, universal serial bus output, SCSI, Firewire (IEEE 1394) output, or any other interface as may be appropriate for a selected application. Finally, the input/output interface 616 is suitably in data communication with a pointing device interface 626 for connection with devices, such as a mouse, light pen, touch screen, or the like.

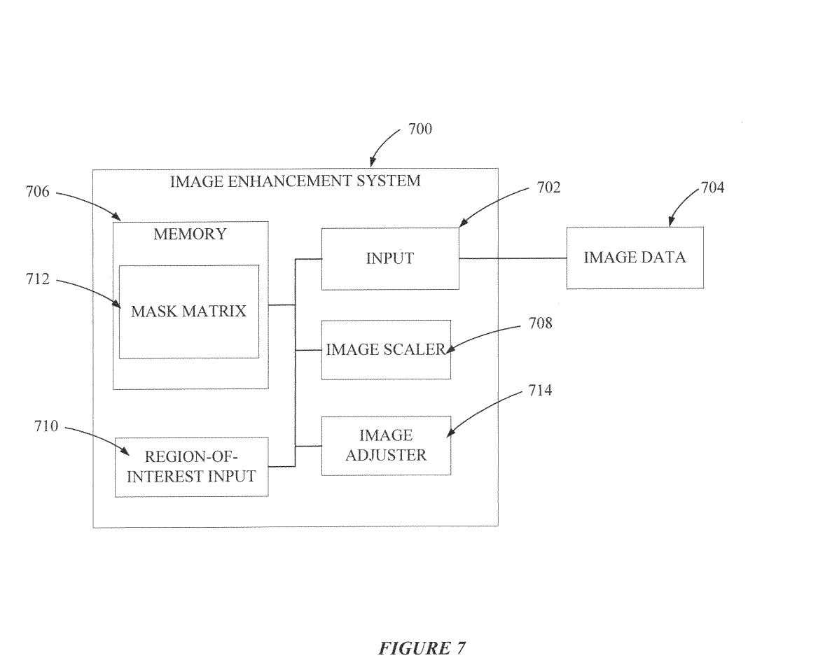

Turning now to FIG. 7, illustrated is a block diagram of a system 700 of image enhancement in accordance with one embodiment of the subject application. The system 700 includes an input 702 operable to receive image data 704 that is comprised of a rectangular array of pixels that are encoded in a multidimensional color space. The system 700 also includes a memory 706 that is configured to store the input image data 704. In addition, the image enhancement system 700 incorporates an image scaler 708 that is configured to scale the image data 704 to a scaled rectangular array of pixels having a smaller number of pixels than the rectangular array of the received image data 704 such that a selected rectangular dimension of the received image data 704 is scaled to a preselected dimension value. In one embodiment of the subject application, a complementary dimension of the input image data 704 to the selected rectangular dimension is also scaled correspondingly.

The system 700 also includes a region-of-interest input 710 operable to receive region-of-interest data corresponding to at least one isolated region of interest in the received image data 704. The memory 706 of the image enhancement system 700 further stores a mask matrix 712 that has a rectangular array of elements corresponding to pixels of the scaled rectangular array. According to one embodiment of the subject application, the mask matrix 712 has a first value associated with each entry corresponding to a region of interest of image data 704 in the scaled rectangular array. The mask matrix 712 in such an embodiment further includes a second value associated with each entry not corresponding to the region of interest, with the mask matrix 712 being populated in accordance with received region-of-interest data. The system 700 also includes an image adjuster 714 that is configured to perform an image adjustment operation on the received image data 704 based upon image data values corresponding to pixel values associated with elements of the mask matrix 712 that have the first value.

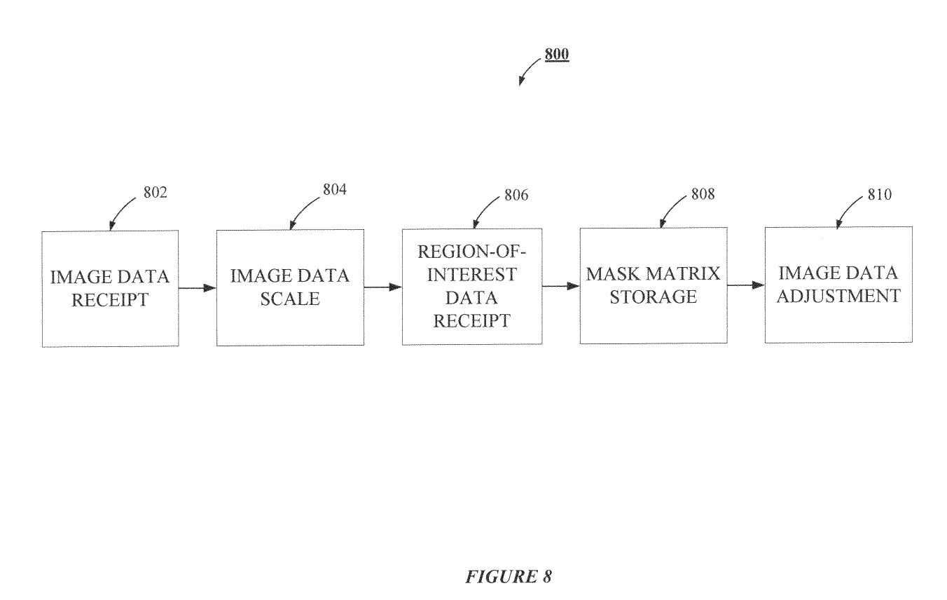

Referring now to FIG. 8, there is shown a functional diagram illustrating the system 800 of image enhancement in accordance with one embodiment of the subject application. As shown in FIG. 8, image data receipt 802 into a memory first occurs of image data comprised of a rectangular array of pixels that are encoded in a multidimensional color space. Image data scale 804 is then performed via the scaling of the image data to a scaled rectangular array of pixels that has a smaller number of pixels than the rectangular array of the received image data such that a selected rectangular dimension of the received image data is scaled to a preselected dimension value. Preferably, a complementary dimension of the selected rectangular dimension of the received image data is scaled correspondingly thereto.

Region-of-interest data receipt 806 then occurs of at least one isolated region of interest in the received image data. Mask matrix storage 808 is then performed of a matrix having a rectangular array of elements corresponding to pixels of the scaled rectangular array. Preferably, the mask matrix has a first value associated with each entry corresponding to a region of interest of the image data in the scaled rectangular array, and a second value associated with each entry that does not correspond to the region of interest. According to one embodiment of the subject application, the mask matrix is populated in accordance with the received region-of-interest data. Image data adjustment 810 is then performed on the received image data in accordance with image data values corresponding to pixel values associated with mask matrix elements having the first value.

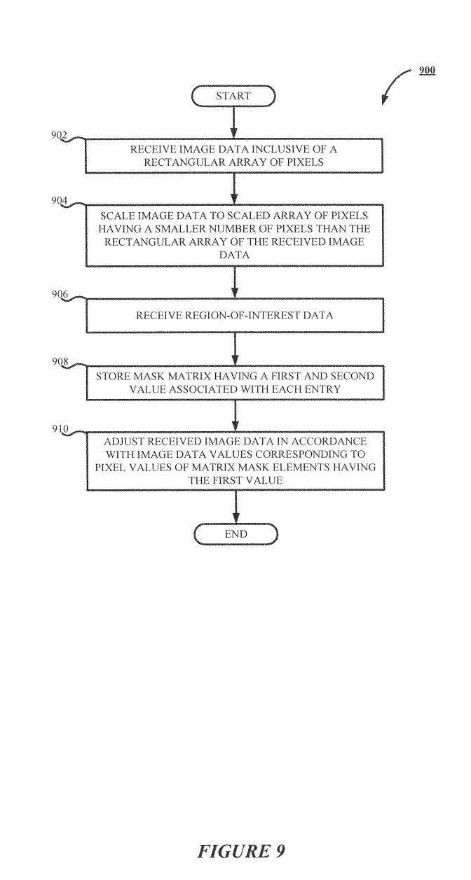

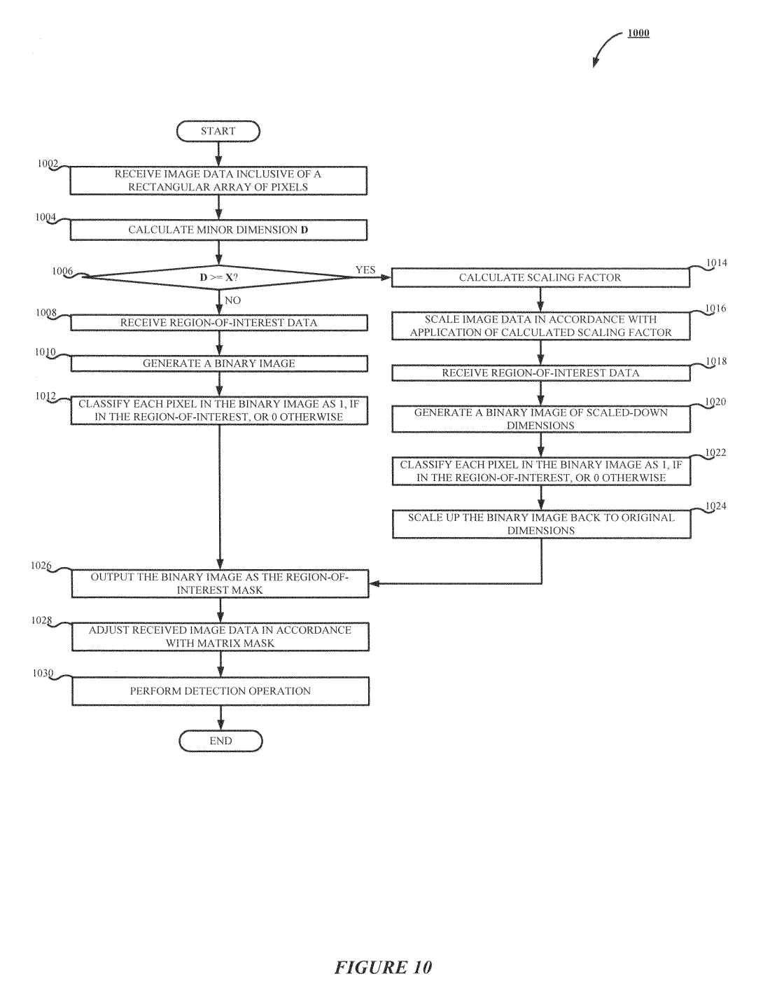

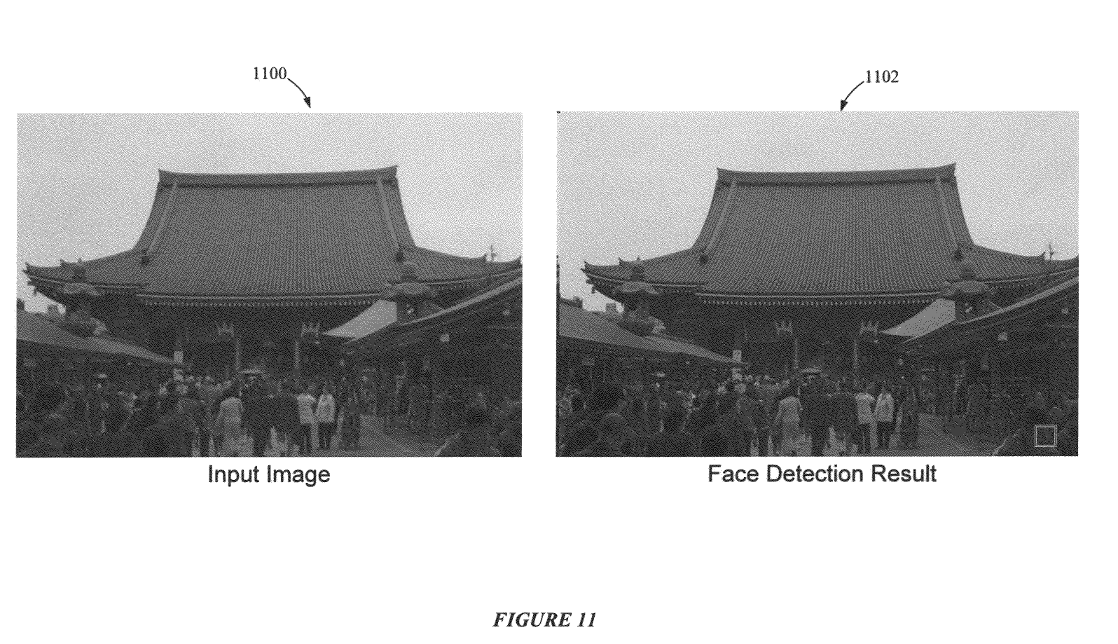

The skilled artisan will appreciate that the subject system 100 and components described above with respect to FIG. 1, FIG. 2, FIG. 3, FIG. 4, FIG. 5, FIG. 6, FIG. 7, and FIG. 8 will be better understood in conjunction with the methodologies described hereinafter with respect to FIG. 9 and FIG. 10, as well as the example implementations illustrated in FIGS. 11-22. Turning now to FIG. 9, there is shown a flowchart 900 illustrating a method of image enhancement in accordance with one embodiment of the subject application. Beginning at step 902, image data is received into a memory, which data is comprised of a rectangular array of pixels encoded in a multidimensional color space. The image data is then scaled at step 904 to a scaled rectangular array of pixels having a smaller number of pixels than the rectangular array of the received image data. According to one embodiment of the subject application, the scaling is performed such that a selected rectangular dimension of the received image data is scaled to a preselected dimension value, and a dimension complementary to the selected rectangular dimension of the image data is also correspondingly scaled.

At step 906, region-of-interest data is received that corresponds to at least one isolated region of interest in the received image data. A mask matrix is then stored in the memory at step 908, which matrix has a rectangular array of elements corresponding to pixels of the scaled rectangular array. According to one example embodiment of the subject application, the mask matrix has a first value associated with each entry corresponding to a region of interest of image data in the scaled rectangular array, and also has a second value associated with each entry not corresponding to the region of interest. In such an example embodiment, the mask matrix is populated in accordance with the received region-of-interest data. Thereafter, at step 910, the received image data is adjusted according to image data values corresponding to the pixel values associated with mask elements having the first value

Referring now to FIG. 10, there is shown a flowchart 1000 illustrating a method of image enhancement in accordance with one embodiment of the subject application. The methodology of FIG. 10 begins at step 1002, whereupon input image data is received by the document processing device 104, the user device 116, or other suitable device capable of processing the received image data in accordance with the methodology of FIG. 10. It will be appreciated by those skilled in the art that the input image data is preferably comprised of a rectangular array of pixels encoded in a multidimensional color space, e.g. RGB, YCrCb, CMYK, or the like. In accordance with one embodiment of the subject application, the image data is stored in memory, i.e. the data storage device 110 associated with the document processing device 104, the data storage device 118 associated with the user device 116, or the like.

At step 1004, the controller 108, the user device 116, or other suitable processing device calculates the minor dimension (D) of the received image data. For example, when the received input image data is 1200 pixels high by 1600 pixels wide, the minor dimension D is 1200 pixels. A determination is then made at step 1006 whether the minor dimension D is greater than or equal to a preselected dimension value (X). For example purposes only, the skilled artisan will appreciate that a suitable preselected dimension value X is 480 pixels, which will be understood to reduce computational requirements of image processing substantially. In the event that the minor dimension D is greater than or equal to the preselected dimension value X, operations proceed to step 1008.

At step 1008, a scaling factor is calculated with respect to the variation between the minor dimension D and the preselected dimension value X. Continuing with the example above, a suitable scaling factor of the minor dimension D of 1200 pixels is 2.5. The scaling factor is then applied to the input image at step 1010 so as to scale the input image to a smaller size. That is, the input image is scaled down to a rectangular array of pixels having a smaller number of pixels than the original rectangular array of pixels of the input image. Continuing with the aforementioned example, application of the scaling factor 2.5 to the input image at 1200×1600 results in a scaled input image of 480×640.

Region-of-interest data is then received at step 1012 corresponding to at least one isolated region of interest in the received image data. According to one embodiment of the subject application, the region-of-interest data includes data representing pixel values associated with a preselected distance from an edge of the rectangular array of pixels of the scaled image data. The skilled artisan will appreciate that such a distance, e.g. in the range of 5% to 15% from the edge of the array is capable of pertaining to the scaled or non-scaled image data. In accordance with another embodiment of the subject application, the region-of-interest data includes data corresponding to a color range, such as a color range associated with skin tones.

A binary image, or matrix, of scaled-down dimensions corresponding to the rectangular array is then generated at step 1014. That is, the binary matrix includes a rectangular array of elements corresponding to pixels of the scaled rectangular array. At step 1016, pixels in the region-of-interest are classified as having a first value (one) and pixels outside the region-of-interest are classified as having a second value (zero). Thus, the binary matrix has a one value associated with each entry corresponding to a pixel in the region of interest of image data in the scaled rectangular array and a zero value associated with each entry not corresponding to a pixel in the region of interest. At step 1018, the binary image is then scaled back to the original dimensions. Operations then proceed to step 1026, whereupon the binary image is output as a region-of-interest mask.

Returning to step 1006, upon a determination that the minor dimension D is not greater than or equal to the preselected dimension value X, flow proceeds to step 1020. At step 1020, region-of-interest data is received, which corresponds to an isolated region of interest in the received image data. A binary matrix is then generated at step 1022 having elements corresponding to the pixels of the received input image. At step 1024, elements corresponding to pixels in the region-of-interest in the binary matrix are classified as having a first value (one) and pixels outside the region-of-interest are classified as having a second value (zero). This binary matrix is then output at step 1026 as a region of interest mask. It will be appreciated by those skilled in the art that pixel values in the associated mask are capable of application for the detection of a backlit image portion in the region-of-interest, a facial image portion in the region of interest, or the like. Preferably, such detection is based upon pixels of the received image corresponding to pixel values associated with mask matrix elements having the first value. Therefore, at step 1028, the input image is adjusted in accordance with the application of the mask matrix to the input image. At step 1030, detection is performed of the masked input image in accordance with a desired detection operation, e.g. backlit, facial, or the like.

The foregoing example embodiment of FIG. 10 will be better understood in view of application of the region-of-interest mask in facial detection according to the example images of FIGS. 11-22. FIG. 11 illustrates a suitable input image 1100, which, as the skilled artisan will appreciate is a backlit input image. Facial detection results 1102 illustrate a detected face in the backlit image 1100. It will be understood by those skilled in the art that such facial detection is advantageously ignored for automatic backlit correction purposes, particularly when the face to be detected in the periphery of an input image, i.e. not in the main attraction of the image. Preferably, the input image 1100 is to be corrected as a backlit scene, not as a backlit face. The skilled artisan will appreciate that different algorithms are capable of application for correction of backlit scenes and backlit faces. Current implementations of facial detection result in an attempt to locate all faces in an input image, including such faces as depicted in the periphery of FIG. 11.

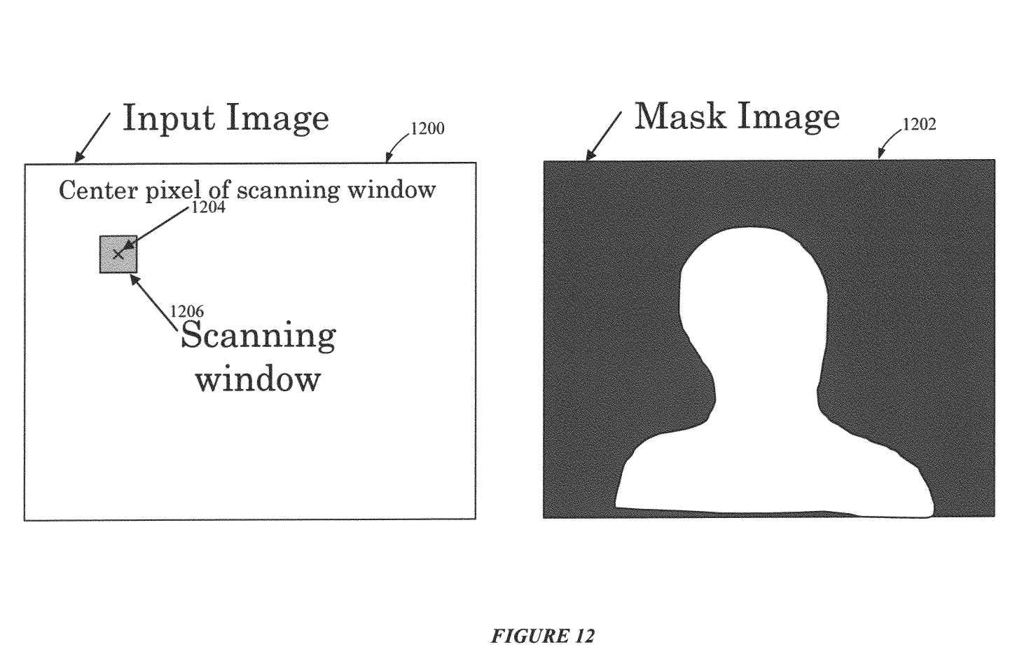

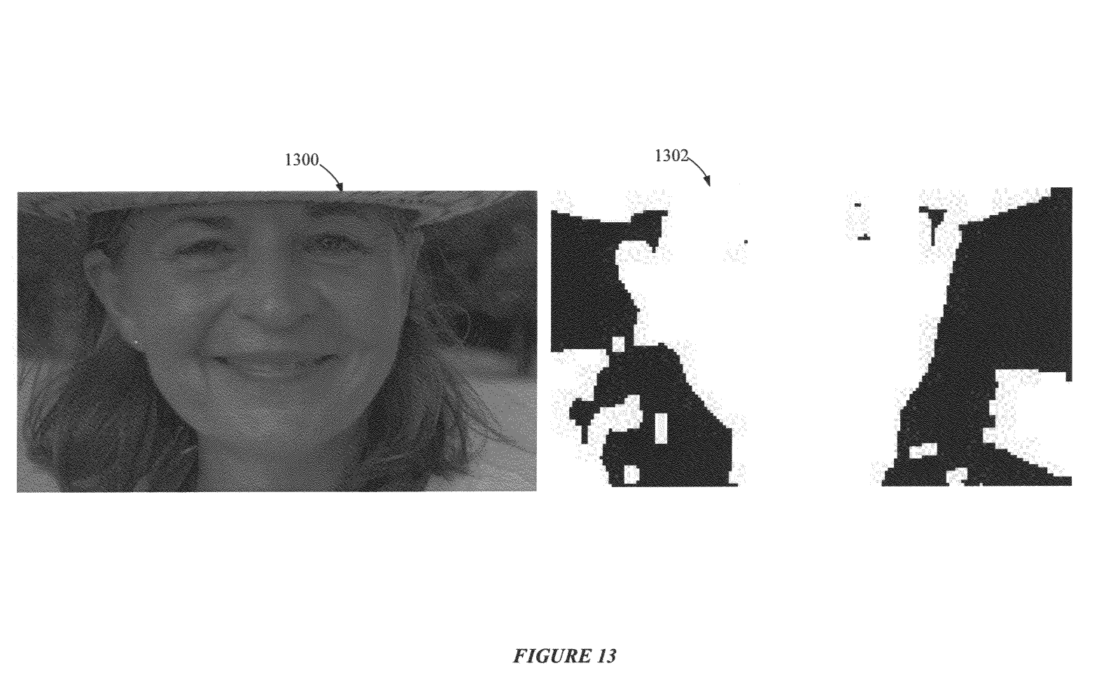

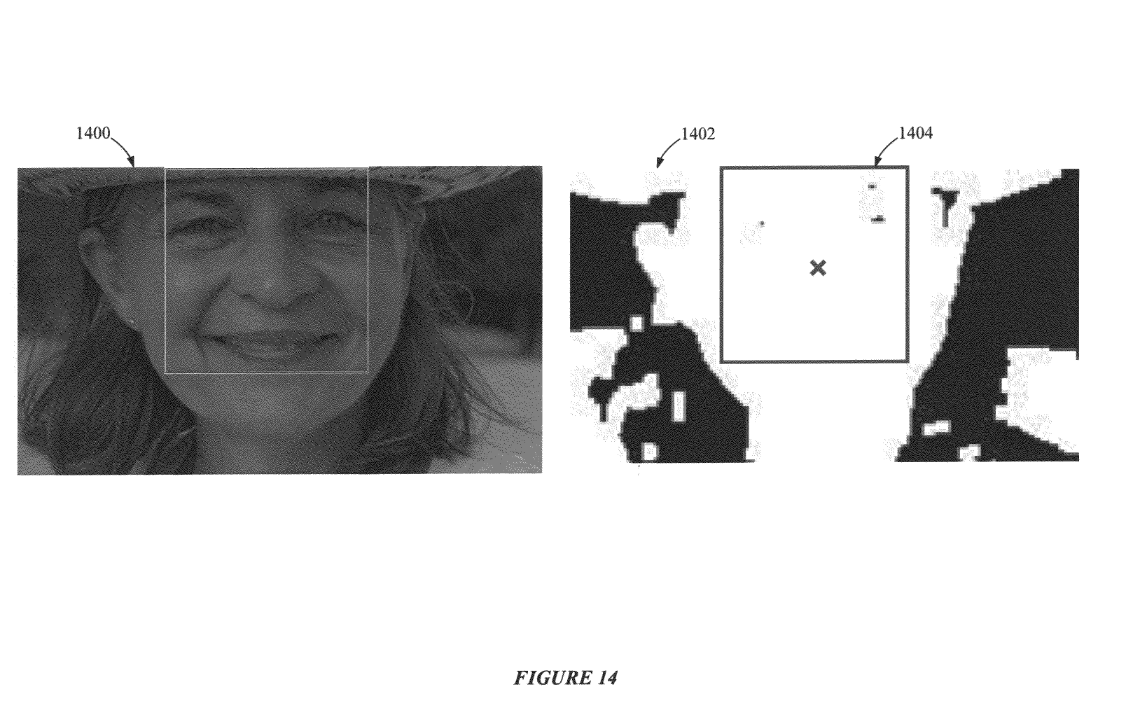

According to one embodiment of the subject application, the methodology described herein is capable of application to leveraging masking schemes so as to create masks for blocking pixels in regions ancillary to the main attraction of an input image. For example, given an image, a face detector locates all human faces by testing if there is a face in a scanning window of various sizes in scan line orders, i.e., from top-left to bottom-right. FIG. 12 depicts one such facial detection methodology for an input image 1200, wherein a masking scheme 1202 is provided to block off pixels on which face detection is performed, that is, if the center pixel 1204 of the scanning window 1206 is zero in the mask image then the detection is skipped (ignored) by the facial detection methodology. In addition, a skin tone mask scheme is capable of being implemented so as to mask off pixels that are determined as not having a skin tone color. FIG. 13 shows an input image 1300 and its skin tone mask 1302. Accordingly, FIG. 14 illustrates the detection result 1400 with such a skin tone mask 1402 (colored in blue with a mark indicating the center of the detection box is not zero in the mask 1402).

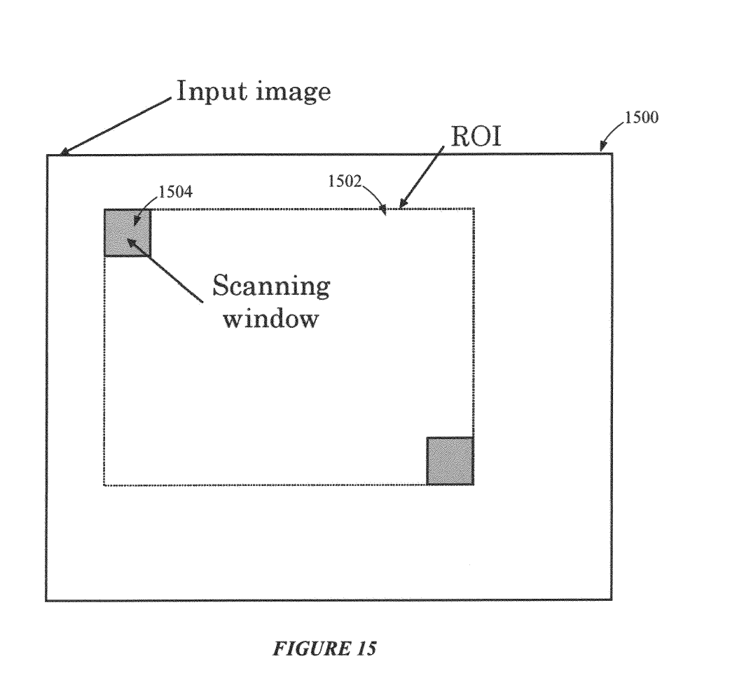

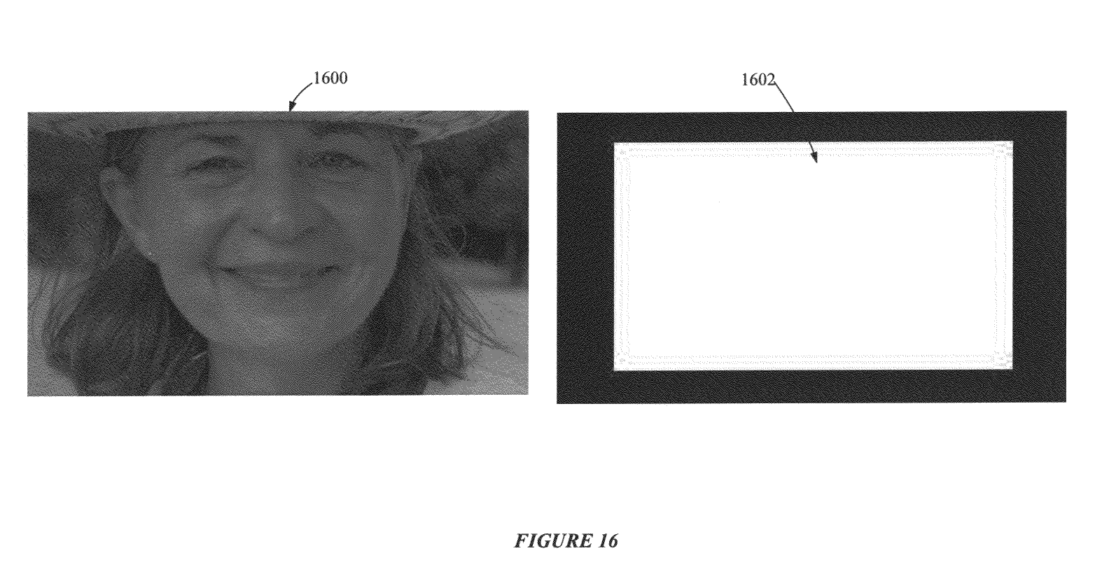

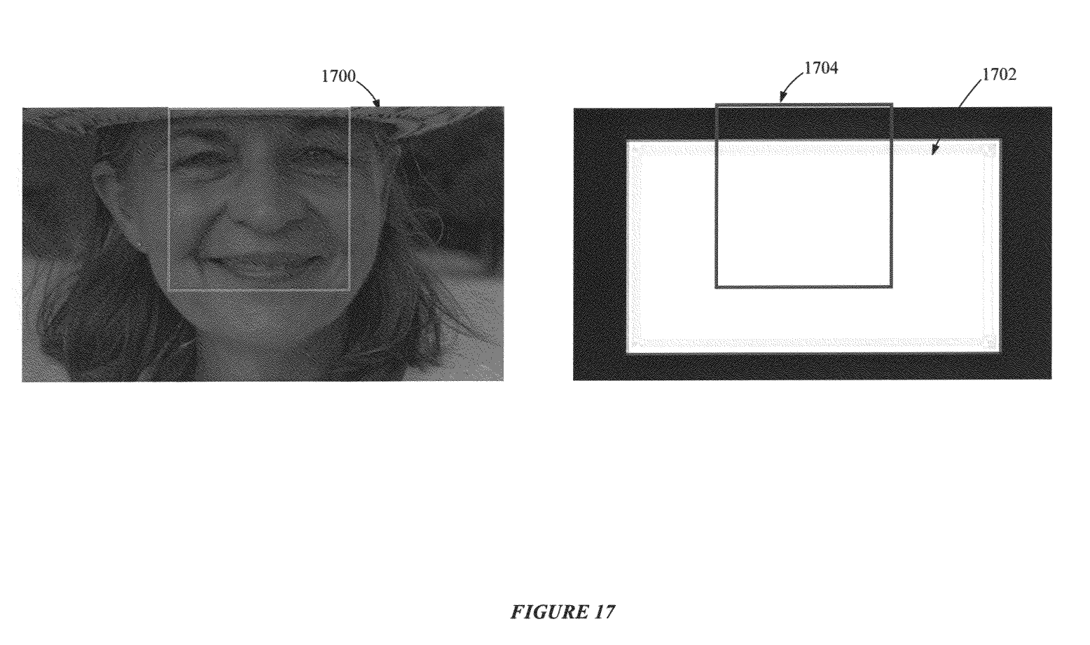

Certain facial detection methodologies are also provided with a region-of-interest scheme to specify regions in which face detection is to be performed. For example, FIG. 15 illustrates that if the entire scanning window 1504 is within the region-of-interest 1502 of the input image 1500, then face detection will occur, otherwise the face detection is skipped (ignored) during facial detection operations. FIG. 16 shows an input image 1600 with a region-of-interest mask 1602. The region-of-interest scheme is suitably illustrated using the input image 1700 in FIG. 17, (1600 of FIG. 16) where a face up to the top edge would have been missed during facial detection operations if region-of-interest 1602 in FIG. 16 is enforced because the detection box 1704 (colored in blue corresponding to the scanning window) is not entirely within the region-of-interest 1702 (indicated as the white region).

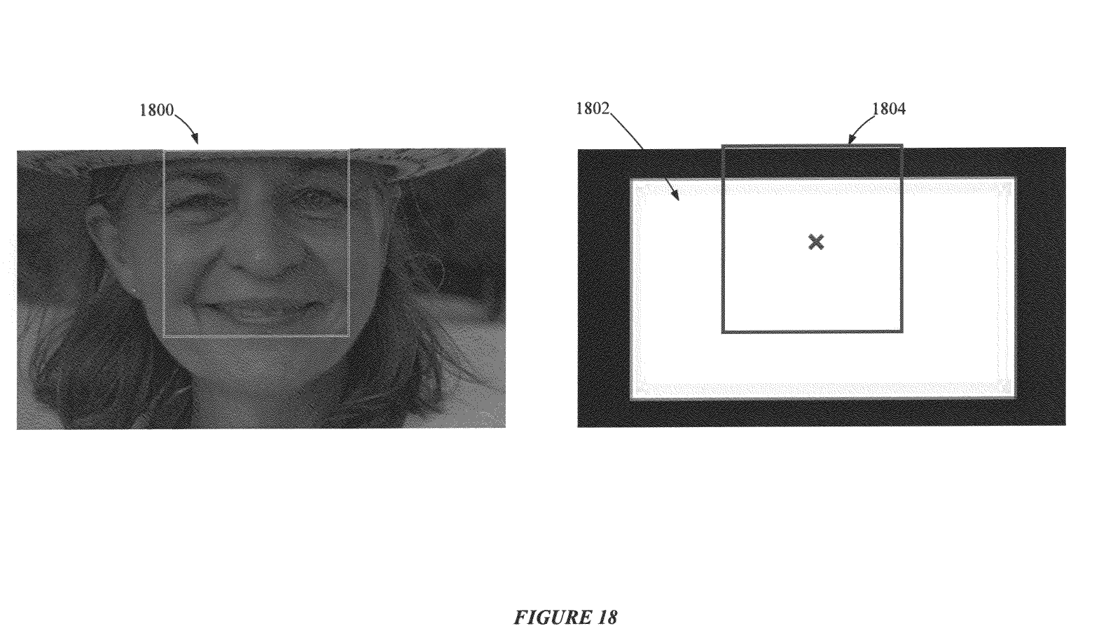

The skilled artisan will appreciate however, that the methodology of the subject application with respect to the region-of-interest, which specifies regions in which face detection operations are to be performed is capable of being materialized as a masking scheme using the aforementioned region-of-interest masks. For example, FIG. 18 depicts a successful face detection result of the face in the input image 1800 (1600 and 1700, respectively, in FIGS. 16 and 17) using a region-of-interest mask in accordance with the subject application, due to the occurrence of the center of the detection box 1804 (instead of the entire detection box 1704 in FIG. 17) being included in the region-of-interest 1802 (the white region). The skilled artisan will appreciate the subtle, and yet crucial difference during facial detection operations.

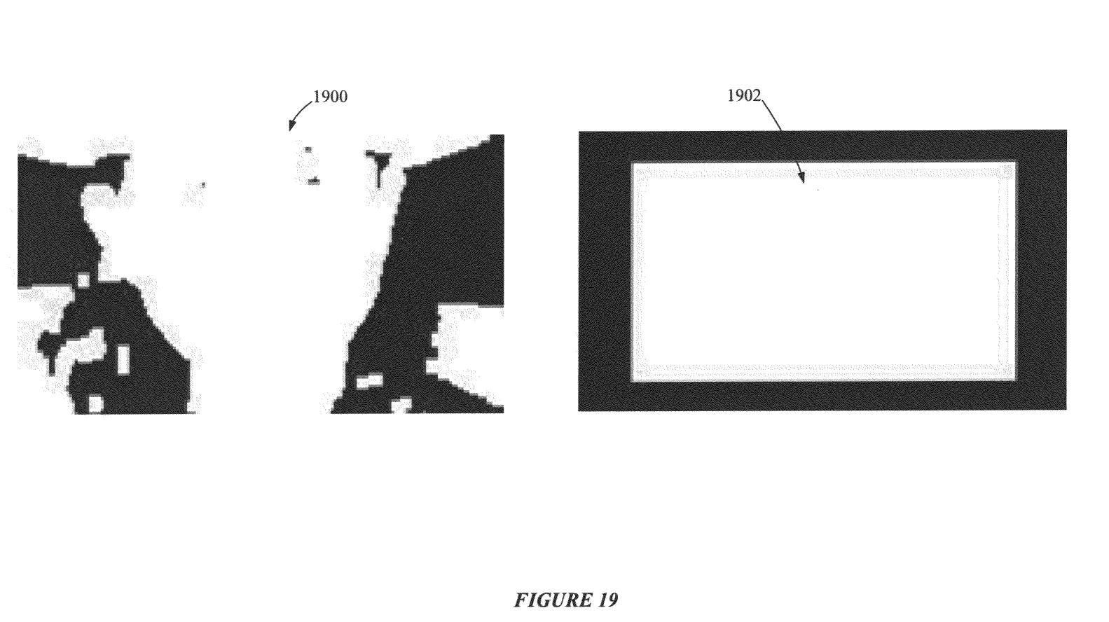

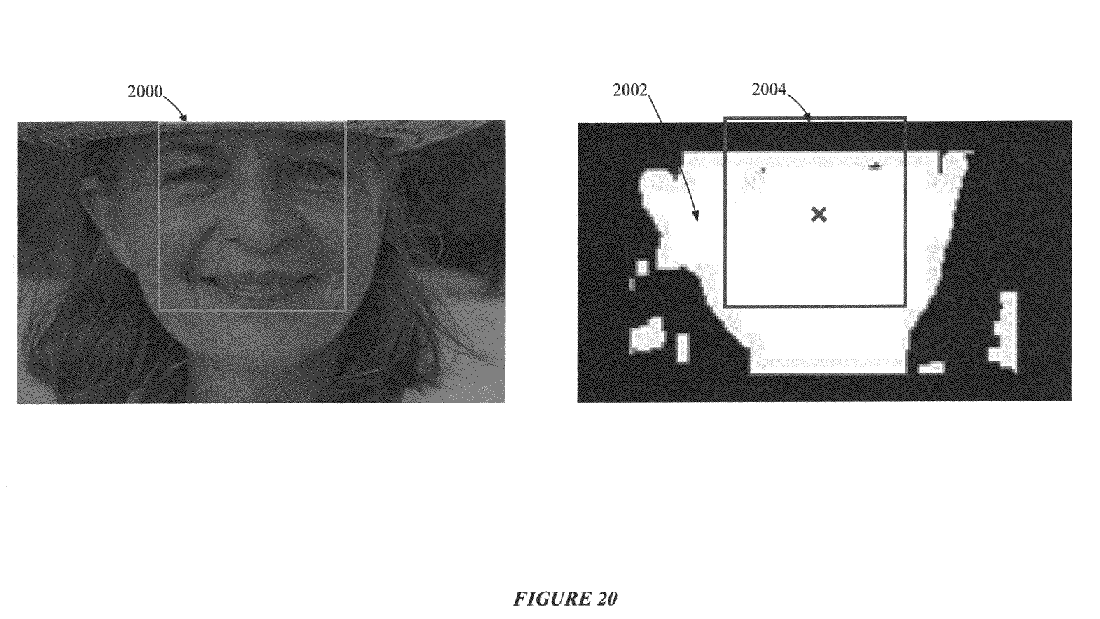

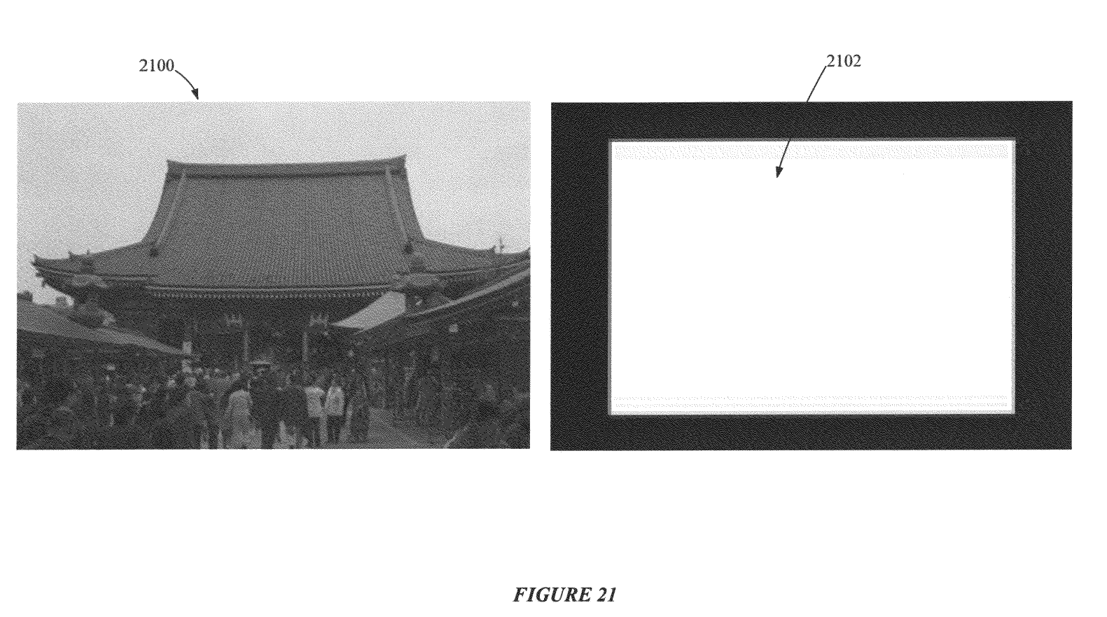

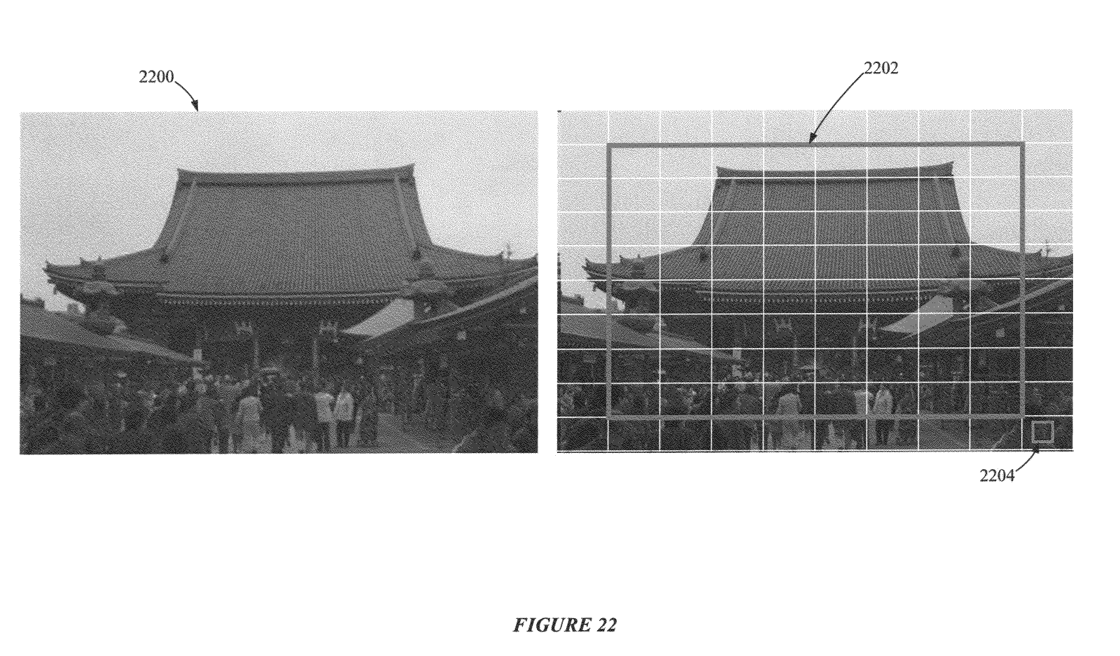

In addition, the region-of-interest mask generated in accordance with one embodiment of the subject application is capable of being logically combined with other masks, e.g. the skin tone mask referenced above. For example, FIG. 19 shows the skin tone mask 1900 and the region-of-interest mask 1902, and FIG. 20 illustrates the input image 2000 with the logically combined mask 2002 (the white region) depicting the successful detection result since the center of the detection box 2004 (colored in blue) is included in the combined mask 2002. FIG. 21 shows the same example input image 2100 as the image 1100 in FIG. 11, with a region-of-interest mask 2102 blocking off approximately 10% of the peripheral regions of the input image 2100. Furthermore, FIG. 22 illustrates application of the methodology of the subject application to the input image 1100 of FIG. 11 (shown as the input image 2200 of FIG. 22). Thus, when the region-of-interest mask 2202 (2102 in FIG. 21) is enforced (i.e. applied to the input image 2200), the unwanted face at the lower right corner, indicated by the detection box 2204, would be missed during face detection operations because the center of the detection box 2204 is located outside the region-of-interest mask 2202 (colored in red).

Thus, the skilled artisan will appreciate that application of the methodologies described above with respect to FIGS. 7-10 advantageously prevent unwanted faces from detection during facial detection operations, and additionally provide for an increase in performance due to the skipping of pixels during processing. For example, using the region-of-interest mask referenced above to block or mask 10% of the peripheral of an input image results in a reduction of classifications from 855536 without the region-of-interest mask to 654242, a 24% reduction with application of the region-of-interest mask. It will be understood by those skilled in the art that the preceding examples and illustrations are intended to explain, rather than limit, the application and methods described and claimed herein.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. An image enhancement system comprising:
an input operable to receive image data comprised of a rectangular array of pixels encoded in a multidimensional color space;
a memory storing the input image data;
an image scaler operable to scale the image data to a scaled rectangular array of pixels having a smaller number of pixels than the rectangular array of the received image data, such that a selected rectangular dimension of the received image data is scaled to a preselected dimension value, and wherein a complementary dimension of the input image data to the selected rectangular dimension is scaled correspondingly thereto;
an input operable to receive region-of-interest data corresponding to at least one isolated region of interest in the received image data;
the memory further storing a mask matrix having a rectangular array of elements corresponding to pixels of the scaled rectangular array, the mask matrix having a first value associated with each entry corresponding to a region of interest of image data in the scaled rectangular array and a second value associated with each entry not corresponding to the region of interest, wherein the mask matrix is populated in accordance with received region-of-interest data; and
an image adjuster operable to perform an image adjustment operation on the received image data in accordance with image data values corresponding to pixel values associated with mask matrix elements having the first value.

2. The system of claim 1 wherein the region-of-interest data includes data representative of pixel values associated with a preselected distance from an edge of the rectangular array of pixels of the scaled image data.

3. The system of claim 2 further comprising a backlit image detector operable on pixels of the received image data corresponding to pixel values associated with mask matrix elements having the first value.

4. The system of claim 2 further comprising a facial image detector operable on pixels of the received image corresponding to pixel values associated with mask matrix elements having the first value.

5. The system of claim 2 wherein the preselected distance is in the range of 5% to 15% of a corresponding dimension of the scaled rectangular array.

6. The system of claim 1 wherein the region-of-interest data includes data representative of a preselected color range.

7. The system of claim 6 wherein the region-of-interest data further includes data corresponding to a color range associated with skin tones.

8. A method of image enhancement comprising:
receiving image data comprised of a rectangular array of pixels encoded in a multidimensional color space into a memory;
scaling the image data to a scaled rectangular array of pixels having a smaller number of pixels than the rectangular array of the received image data such that a selected rectangular dimension of the received image data is scaled to a preselected dimension value, and wherein a complementary dimension of the input image data to the selected rectangular dimension is scaled correspondingly thereto;
receiving region-of-interest data corresponding to at least one isolated region of interest in the received image data;
storing, in the memory, a mask matrix having a rectangular array of elements corresponding to pixels of the scaled rectangular array, the mask matrix having a first value associated with each entry corresponding to a region of interest of image data in the scaled rectangular array and a second value associated with each entry not corresponding to the region of interest, wherein the mask matrix is populated in accordance with received region-of-interest data; and
adjusting the received image data in accordance with image data values corresponding to pixel values associated with mask matrix elements having the first value.

9. The method of claim 8 wherein the region-of-interest data includes data representative of pixel values associated with a preselected distance from an edge of the rectangular array of pixels of the scaled image data.

10. The method of claim 9 further comprising detecting a backlit image portion on pixels of the received image data corresponding to pixel values associated with mask matrix elements having the first value.

11. The method of claim 9 further comprising detecting a facial image portion on pixels of the received image corresponding to pixel values associated with mask matrix elements having the first value.

12. The method of claim 9 wherein the preselected distance is in the range of 5% to 15% of a corresponding dimension of the scaled rectangular array.

13. The method of claim 8 wherein the region-of-interest data includes data representative of a preselected color range.

14. The method of claim 13 wherein the region-of-interest data further includes data corresponding to a color range associated with skin tones.

15. A system of image enhancement comprising:
means adapted for receiving image data comprised of as a rectangular array of pixels encoded in a multidimensional color space into a memory;
means adapted for scaling the image data to a scaled rectangular array of pixels having a smaller number of pixels than the rectangular array of the received image data such that a selected rectangular dimension of the received image data is scaled to a preselected dimension value, and wherein a complementary dimension of the input image data to the selected rectangular dimension is scaled correspondingly thereto;
means adapted for receiving region-of-interest data corresponding to at least one isolated region of interest in the received image data;
means adapted for storing, in the memory, a mask matrix having a rectangular array of elements corresponding to pixels of the scaled rectangular array, the mask matrix having a first value associated with each entry corresponding to a region of interest of image data in the scaled rectangular array and a second value associated with each entry not corresponding to the region of interest, wherein the mask matrix is populated in accordance with received region-of-interest data; and
means adapted for adjusting the received image data in accordance with image data values corresponding to pixel values associated with mask matrix elements having the first value.

16. The system of claim 15 wherein the region-of-interest data includes data representative of pixel values associated with a preselected distance from an edge of the rectangular array of pixels of the scaled image data.

17. The system of claim 16 further comprising means adapted for detecting a backlit image portion on pixels of the received image data corresponding to pixel values associated with mask matrix elements having the first value.

18. The system of claim 16 further comprising means adapted for detecting a facial image portion on pixels of the received image corresponding to pixel values associated with mask matrix elements having the first value.

19. The system of claim 16 wherein the preselected distance is in the range of 5% to 15% of a corresponding dimension of the scaled rectangular array.

20. The system of claim 15 wherein the region-of-interest data includes data representative of a preselected color range and the region-of-interest data further includes data corresponding to a color range associated with skin tones.
